(19) United States
(12) Patent Application Publication
(10) Pub. No.: US 2025/0268123 A1
(43) Pub. Date: Aug. 28, 2025

(54) Integrated Device for Soybean Sowing and Fertilization

(71) Applicant: Huanghuai University, Zhumadian (CN)

(72) Inventors: Weizhong XIAO, Zhumadian (CN); Jiangtao WANG, Zhumadian (CN); Wenjuan CHU, Zhumadian (CN); Jingyun ZHAO, Zhumadian (CN); Chunlei MA, Zhumadian (CN); Dongsheng WANG, Zhumadian (CN)

(73) Assignee: Huanghuai University, Zhumadian (CN)

(21) Appl. No.: 18/587,978

(22) Filed: Feb. 27, 2024

(51) Int. Cl. A01C 7/06; A01C 7/20

(52) U.S. Cl. CPC A01C 7/06; A01C 7/206

(57) ABSTRACT

An integrated device for soybean sowing and fertilization is provided, including a mobile base, a fertilizer storage unit is installed at one end of the upper side of the mobile base, a sowing box is installed at the other end thereof, a seed storage box is connected to the upper end of the sowing box, a sowing disc is rotationally installed inside the sowing box, a plurality of sowing troughs are arranged at an outer edge of the sowing disc, a quantity adjustment plate is slidably installed inside the sowing trough, a quantity adjustment mechanism for changing a position of the quantity adjustment plate is arranged on the sowing box, a sowing tube is installed at the bottom of the mobile base, a fertilizing chamber is installed at the bottom of the sowing tube, and the fertilizer storage unit is provided with a fertilizing mechanism.

### TECHNICAL FIELD

The present disclosure relates to the technical field of soybean planting, and particularly to an integrated device for soybean sowing and fertilization.

### BACKGROUND

Soybean is an annual herbaceous plant belonging to the Fabaceae family, with a height of 30-90 cm. A stem of the soybeans is robust, erect and densely covered with long, brown and stiff hairs. A leaf usually has three leaflets; a stipule is veined and covered with yellow pubescence; a petiole is 2-20 cm in length; a leaflet is broadly ovate and papery; a short raceme is few-flowered, and a long one has many flowers; a peduncle usually bears 5-8 sessile and closely packed flowers; a bract is lanceolate and covered with strigose hairs; a bracteole is lanceolate and covered with appressed setae; and a calyce is lanceolate, flowers are purple, lavender or white, a base has a petiole and a wing petal is grate-shaped. A pod is plump, slightly curved, pendant, yellowish-green, and densely covered with brownish-yellow long hairs; there are 2-5 oval or nearly spherical seeds, with smooth seed coats in light green, yellow, brown or black. The flowering period of soybean is from June to July, and the fruiting period is from July to September.

Currently, traditional soybean sowing and fertilizing involve separate and independent equipment. An operator has to sow soybeans first, and then fertilize the soil around the soybeans, this method is time-consuming and labor-intensive, not only increasing the workload for operators, but also reducing the efficiency of soybean planting. Therefore, further improvements are needed.

### SUMMARY

An objective of the present disclosure is to provide an integrated device for soybean sowing and fertilization, so as to solve the problems mentioned in the background art.

In order to achieve the above objective, the present disclosure provides the following technical solution:
an integrated device for soybean sowing and fertilization, including a mobile base, a fertilizer storage unit is installed at one end of the upper side of the mobile base, a sowing box is installed at the other end of the upper side of the mobile base, a seed storage box is connected to the upper end of the sowing box, a sowing disc is rotationally installed inside the sowing box, a plurality of sowing troughs are arranged at an outer edge of the sowing disc, a quantity adjustment plate is slidably installed inside the sowing trough, a quantity adjustment mechanism for changing a position of the quantity adjustment plate inside the sowing trough is arranged on the sowing box, a sowing tube is installed at the bottom of the mobile base, a fertilizing chamber is installed at the bottom of the sowing tube, and the fertilizer storage unit is provided with a fertilizing mechanism for introducing fertilizer inside the fertilizer storage unit into the fertilizing chamber.

As an improved solution of the present disclosure, mobile frames are fixedly installed at four corners of the lower end of the mobile base, a traveling shaft is rotationally installed between the mobile frames, and traveling wheels are fixedly installed at both ends of the traveling shaft.

As an improved solution of the present disclosure, a sowing shaft is fixedly connected to a center position of an end of the sowing disc, and the end of the sowing shaft away from the sowing disc passes through the sowing box and is connected to the end position of one of the traveling shafts through a belt pulley set b.

As an improved solution of the present disclosure, the fertilizing mechanism includes a fertilizing pump installed outside the fertilizer storage unit, an input end of the fertilizing pump is connected to the bottom of the fertilizer storage unit through a fertilizer inlet pipe, an output end of the fertilizing pump is connected to the fertilizing chamber through a fertilizer outlet pipe, and a power end of the fertilizing pump is connected to the sowing shaft through a belt pulley set a.

As an improved solution of the present disclosure, a stirring shaft is rotationally installed inside the fertilizer storage unit, one end of the stirring shaft is connected to the power end of the fertilizing pump, a plurality of stirring blades are installed at an outer side of the stirring shaft, and the other end of the stirring shaft is connected to a stirring motor fixed on the fertilizer storage unit.

As an improved solution of the present disclosure, the quantity adjustment mechanism includes an empty groove set inside the sowing disc, a cam block is rotationally installed inside the empty groove, a snap-fit ball is contacted with an outer side of the cam block, a snap-fit plate is installed on the snap-fit ball, a snap-fit column is installed on the snap-fit plate, the snap-fit column passes through a sowing trough and is connected to a quantity adjustment plate, a snap-fit spring is sleeved on an outer side of the snap-fit column between the snap-fit plate and an inner wall of the empty groove, and the quantity adjustment mechanism further includes a limiting assembly for driving the rotation of the cam block.

As an improved solution of the present disclosure, the limiting assembly includes a rotatable cylinder fixed on an outer wall of the sowing disc, a rotatable shaft connected to the cam block is rotationally installed inside the rotatable cylinder, a limiting plate is installed at an end of the rotatable cylinder, a limiting disc is installed at the end of rotatable shaft far away from the cam block and passing through the limiting plate, and the limiting plate and the limiting disc are arranged through a limiting portion.

As an improved solution of the present disclosure, the limiting portion includes a plurality of limiting holes arranged at the edge of the limiting plate, and a limiting column slidably arranged on the limiting disc is snap-fitted in the limiting hole.

Compared with the prior art, the present disclosure has the following beneficial effects:
the integrated device for soybean sowing and fertilization has a reasonable structure and novel design. Through the mutual cooperation of the fertilizer storage unit and the fertilizing mechanism, the device can achieve effective fertilization of water and fertilizer after sowing. Further, the quantity adjustment mechanism can meet the objective of sowing different quantities of soybean seeds, and the applicable scope of the device is further expanded, featuring strong practicality and high reliability.

### BRIEF DESCRIPTION OF THE DRAWINGS

FIG. 1 is an overall structural schematic diagram from a front view of the present disclosure.

FIG. 2 is an overall structural schematic diagram from a back view of the present disclosure.

FIG. 3 is an overall structural schematic diagram from a top view of the present disclosure.

FIG. 4 is an overall structural schematic diagram from a bottom view of the present disclosure.

FIG. 5 is a structural schematic diagram of a quantity adjustment mechanism of the present disclosure.

In the accompanying drawings: 1. mobile base; 2. fertilizer storage unit; 3. mobile frame; 4. fertilizing pump; 5. fertilizer outlet pipe; 6. traveling shaft; 7. traveling wheel; 8. sowing box; 9. sowing shaft; 10. belt pulley set b; 11. seed storage box; 12. sowing disc; 13. sowing trough; 14. stirring motor; 15. limiting plate; 16. limiting disc; 17. limiting column; 18. limiting hole; 19. stirring shaft; 20. stirring blade; 21. fertilizer inlet pipe; 22. sowing tube; 23. fertilizing chamber; 24. quantity adjustment plate; 25. snap-fit column; 26. snap-fit plate; 27. rotatable shaft; 28. cam block; 29. snap-fit ball; 30. snap-fit spring; 31. rotatable cylinder; and 32. belt pulley set a.

### DETAILED DESCRIPTION OF THE EMBODIMENTS

It should be noted that the embodiments in the present disclosure and features in the embodiments can be combined without conflicts.

In the specification of the present disclosure, it is to be understood that the terms “central”, “longitudinal”, “transverse”, “upper”, “lower”, “front”, “back”, “left”, “right”, “vertical”, “horizontal”, “top”, “bottom”, “inner”, “outer”, etc. indicate azimuthal or positional relations on the basis of those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure. In addition, the terms “first” and “second” are used for descriptive purposes only and should not be construed as indicating or implying a relative importance or implicitly indicating the number of technical features indicated. Therefore, features defining “first” or “second” may explicitly or implicitly include at least one or more of the features. In the description of the present disclosure, unless specifically defined otherwise, the meaning of “a plurality” is at least two or more.

In the description of the present disclosure, it should be noted that, unless otherwise explicitly specified and defined, the terms “mounting”, “connecting” and “connection” should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. For those of ordinarily skilled in the art, specific meanings of the above terms in the present disclosure could be understood according to specific circumstances.

The present disclosure will be described in detail below with reference to the accompanying drawings in conjunction with embodiments.

### Embodiment 1

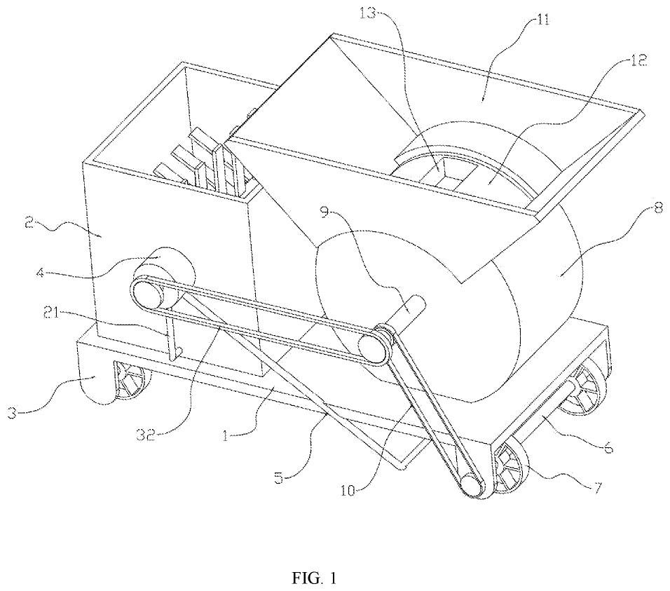

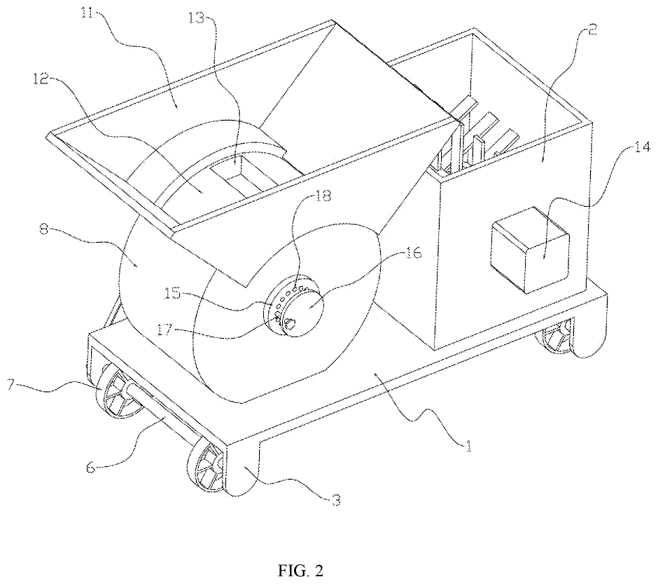

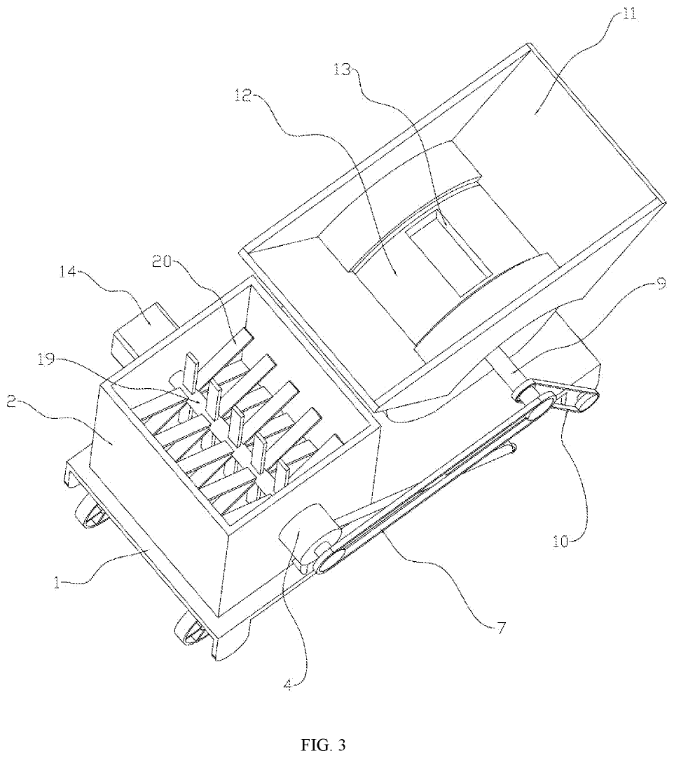

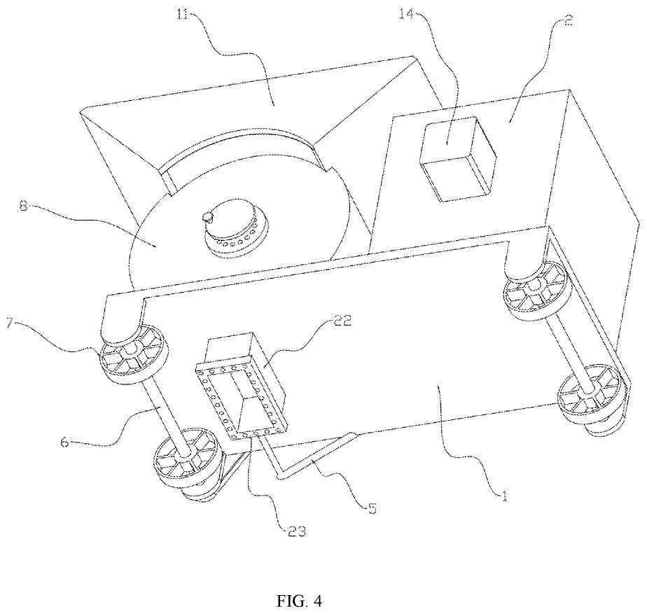

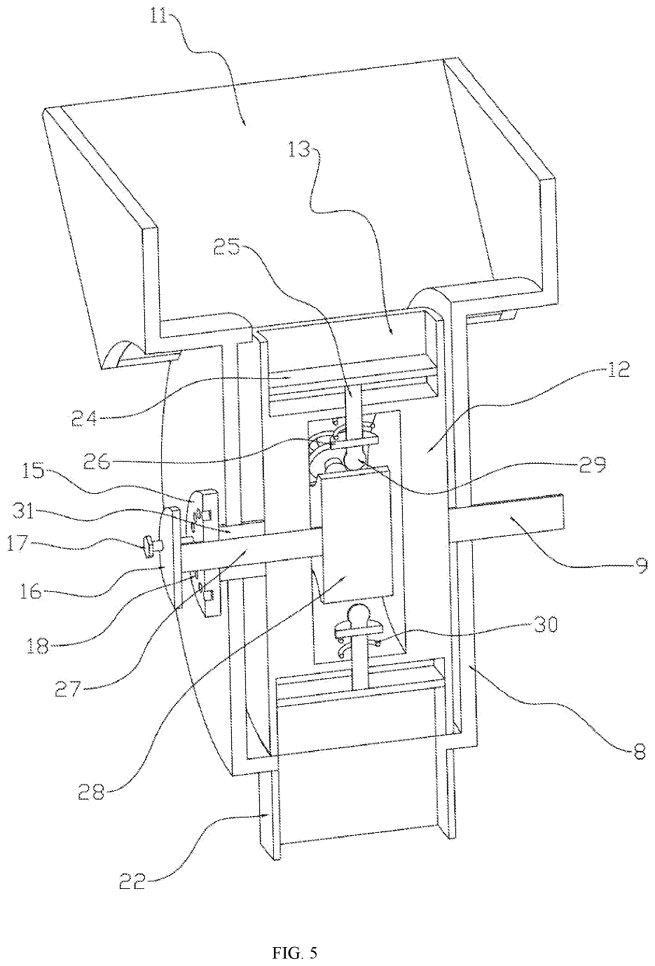

With reference to FIGS. 1-5, in an embodiment of the present disclosure, an integrated device for soybean sowing and fertilization is provided, the device includes a mobile base 1, a fertilizer storage unit 2 containing water and fertilizer inside is installed at one end of the upper side of the mobile base 1, a sowing box 8 is installed at the other end of the upper side of the mobile base 1, a seed storage box 11 containing soybean seeds inside is connected to the upper end of the sowing box 8, a sowing disc 12 is rotationally installed inside the sowing box 8, a plurality of sowing troughs 13 are arranged at an outer edge of the sowing disc 12, a quantity adjustment plate 24 is slidably installed inside the sowing trough 13, a quantity adjustment mechanism for changing a position of the quantity adjustment plate 24 inside the sowing trough 13 is arranged on the sowing box 8, a sowing tube 22 is installed at the bottom of the mobile base, a fertilizing chamber 23 is installed at the bottom of the sowing tube 22, and the fertilizer storage unit 2 is provided with a fertilizing mechanism for introducing fertilizer inside the fertilizer storage unit 2 into the fertilizing chamber 23.

Mobile frames 3 are fixedly installed at four corners of the lower end of the mobile base 1, a traveling shaft 6 is rotationally installed between the mobile frames 3, and traveling wheels 7 are fixedly installed at both ends of the traveling shaft 6. With the above structure, the effective movement of the entire device in the field is ensured, and the reliability of the device is further improved.

A sowing shaft 9 is fixedly connected to a center position of an end of the sowing disc 12, and the end of the sowing shaft 9 away from the sowing disc 12 passes through the sowing box 8 and is connected to the end position of one of the traveling shafts 6 through a belt pulley set b10. With the above structure, the sowing disc 12 is effectively rotated inside the sowing box 8, and finally the sowing requirements of soybean seeds are fulfilled.

The fertilizing mechanism includes a fertilizing pump 4 installed outside the fertilizer storage unit 2, an input end of the fertilizing pump 4 is connected to the bottom of the fertilizer storage unit 2 through a fertilizer inlet pipe 21, an output end of the fertilizing pump 4 is connected to the fertilizing chamber 23 through a fertilizer outlet pipe 5, and a power end of the fertilizing pump 4 is connected to the sowing shaft 9 through a belt pulley set a32. Specifically, with the above structure, the device can achieve the purpose of fertilization after sowing with the action of the fertilizing chamber 23, while the sowing tube 22 sows the soybean seeds, such that the reliability of the device is further improved.

A stirring shaft 19 is rotationally installed inside the fertilizer storage unit 2, one end of the stirring shaft 19 is connected to the power end of the fertilizing pump 4, a plurality of stirring blades 20 are installed at an outer side of the stirring shaft 19, and the other end of the stirring shaft 19 is connected to a stirring motor 14 fixed on the fertilizer storage unit 2. With the above structure, the stirring blades 20 can mix and stir the water and fertilizer inside the fertilizer storage unit 2 when rotating, such that the fertilization effect of the fertilizing mechanism is improved.

### Embodiment 2

Another embodiment of the present disclosure differs from the above embodiment in that the quantity adjustment mechanism includes an empty groove set inside the sowing disc 12, a cam block 28 is rotationally installed inside the empty groove, a snap-fit ball 29 is contacted with an outer side of the cam block 28, a snap-fit plate 26 is installed on the snap-fit ball 29, a snap-fit column 25 is installed on the snap-fit plate 26, the snap-fit column 25 passes through a sowing trough 13 and is connected to a quantity adjustment plate 24, a snap-fit spring 30 is sleeved on an outer side of the snap-fit column 25 between the snap-fit plate 26 and an inner wall of the empty groove, and the quantity adjustment mechanism further includes a limiting assembly for driving the rotation of the cam block 28. With the above structure, the quantity adjustment plate 24 can move radially at a position inside the sowing trough 13, such that a storage volume of the sowing trough 13 is changed, and the adjustment needs of sowing quantity is finally satisfied.

In addition, in this embodiment, the limiting assembly includes a rotatable cylinder 31 fixed on an outer wall of the sowing disc 12, a rotatable shaft 27 connected to the cam block 28 is rotationally installed inside the rotatable cylinder 31, a limiting plate 15 is installed at an end of the rotatable cylinder 31, a limiting disc 16 is installed at the end of rotatable shaft 27 far away from the cam block 28 and passing through the limiting plate 15, and the limiting plate 15 is connected with the limiting disc 16 through a limiting portion. With the above structure, a rotation angle of the cam block 28 can be adjusted more rapidly, such that the adjustment reliability of the quantity adjustment mechanism is finally improved.

Specifically, the limiting portion includes a plurality of limiting holes 18 arranged at the edge of the limiting plate 15, and a limiting column 17 slidably arranged on the limiting disc 16 is snap-fitted in the limiting hole 18. During operation, an operator only needs to insert the limiting column 17 into the limiting hole 18 at different positions, such that rapid adjustment of the quantity adjustment mechanism can be achieved.

The working principle of the present disclosure is as follows: during operation, the stirring motor 14 is activated, on the one hand, the entire device is moved, and on the other hand, the sowing tube 22 continuously sows seeds, the fertilizing mechanism also operates to ensure rapid fertilization of the seeds after sowing. During the sowing process, the quantity of sowing seeds can be rapidly adjusted through the quantity adjustment mechanism, making the entire operation process quick and convenient, and therefore, the device is worthy of promotion and use.

What is described above is merely preferred embodiments of the present disclosure, and is not intended to limit the present disclosure. Any modifications, equivalent replacements and improvements, etc. made within the spirit and principle of the present disclosure should fall within the scope of protection of the present disclosure.

What is claimed is:

1. An integrated device for soybean sowing and fertilization, comprising a mobile base, wherein a fertilizer storage unit is installed at a first end of an upper side of the mobile base, a sowing box is installed at a second end of the upper side of the mobile base, a seed storage box is connected to an upper end of the sowing box, a sowing disc is rotationally installed inside the sowing box, a plurality of sowing troughs are arranged at an outer edge of the sowing disc, a quantity adjustment plate is slidably installed inside each of the plurality of sowing troughs, a quantity adjustment mechanism for changing a position of the quantity adjustment plate inside each of the plurality of sowing troughs is arranged on the sowing box, a sowing tube is installed at a bottom of the mobile base, a fertilizing chamber is installed at a bottom of the sowing tube, and the fertilizer storage unit is provided with a fertilizing mechanism for introducing fertilizer inside the fertilizer storage unit into the fertilizing chamber.

2. The integrated device for the soybean sowing and fertilization according to claim 1, wherein mobile frames are fixedly installed at four corners of a lower end of the mobile base, traveling shafts are rotationally installed between the mobile frames, and traveling wheels are fixedly installed at both ends of the traveling shafts.

3. The integrated device for the soybean sowing and fertilization according to claim 2, wherein a sowing shaft is fixedly connected to a center position of an end of the sowing disc, and an end of the sowing shaft away from the sowing disc passes through the sowing box and is connected to an end position of one of the traveling shafts through a first belt pulley set.

4. The integrated device for the soybean sowing and fertilization according to claim 3, wherein the fertilizing mechanism comprises a fertilizing pump installed outside the fertilizer storage unit, an input end of the fertilizing pump is connected to a bottom of the fertilizer storage unit through a fertilizer inlet pipe, an output end of the fertilizing pump is connected to the fertilizing chamber through a fertilizer outlet pipe, and a power end of the fertilizing pump is connected to the sowing shaft through a second belt pulley set.

5. The integrated device for the soybean sowing and fertilization according to claim 4, wherein a stirring shaft is rotationally installed inside the fertilizer storage unit, a first end of the stirring shaft is connected to the power end of the fertilizing pump, a plurality of stirring blades are installed at an outer side of the stirring shaft, and a second end of the stirring shaft is connected to a stirring motor fixed on the fertilizer storage unit.

6. The integrated device for the soybean sowing and fertilization according to claim 1, wherein the quantity adjustment mechanism comprises an empty groove set inside the sowing disc, a cam block is rotationally installed inside the empty groove, a snap-fit ball is contacted with an outer side of the cam block, a snap-fit plate is installed on the snap-fit ball, a snap-fit column is installed on the snap-fit plate, the snap-fit column passes through each of the plurality of sowing troughs and is connected to the quantity adjustment plate, a snap-fit spring is sleeved on an outer side of the snap-fit column between the snap-fit plate and an inner wall of the empty groove, and the quantity adjustment mechanism further comprises a limiting assembly for driving a rotation of the cam block.

7. The integrated device for the soybean sowing and fertilization according to claim 6, wherein the limiting assembly comprises a rotatable cylinder fixed on an outer wall of the sowing disc, a rotatable shaft connected to the cam block is rotationally installed inside the rotatable cylinder, a limiting plate is installed at an end of the rotatable cylinder, a limiting disc is installed at an end of rotatable shaft far away from the cam block and passing through the limiting plate, and the limiting plate is connected with the limiting disc through a limiting portion.

8. The integrated device for the soybean sowing and fertilization according to claim 7, wherein the limiting portion comprises a plurality of limiting holes arranged at an edge of the limiting plate, and a limiting column slidably arranged on the limiting disc is snap-fitted in one of the plurality of limiting holes.
